(19) United States
(12) Patent Application Publication
(10) Pub. No.: US 2023/0075137 A1
(43) Pub. Date: Mar. 9, 2023

(54) PROFILE SERVICE MANAGEMENT

(71) Applicant: ACCENTURE GLOBAL SOLUTIONS LIMITED, Dublin 4 (IE)

(72) Inventors: Atul ABHYANKAR, West Mumbai (IN); Payal PANDA, Bangalore (IN); Sangita AGARWAL, Bangalore (IN); Suresh KANJUR MANAKKAL, Bangalore (IN); Bharath SRINIVAS, West Mumbau (IN); Raghavan Tinniyam IYER, Bangalore (IN); Gurbir SINGH SETHI, West Mumbai (IN); Sushant ADHIKARI, Bangalore (IN); Satyajeet SUMAN, Gurgaon (IN); Chellappan MURUGAPPAN, Chennai (IN); Edward MILLER, DALLAS, TX (US); Ravishankar KUNNATHUR MURUGESAN, Erode (DT) (IN); Subhasish DAS, Kolkata (IN)

(73) Assignee: ACCENTURE GLOBAL SOLUTIONS LIMITED, Dublin 4 (IE)

(21) Appl. No.: 17/896,046

(22) Filed: Aug. 25, 2022

(30) Foreign Application Priority Data
Aug. 26, 2021 (IN) 202111038682

(51) Int. Cl. G06Q 50/00; G06F 16/9535

(52) U.S. Cl. CPC G06Q 50/01; G06F 16/9535

(57) ABSTRACT

Systems and methods for profile service management are disclosed. A system generates user data corresponding to plurality of users in an electronic meeting (e-meeting), based on meta data received from one or more data sources. The generated user data is stored in data lake. The system retrieves, from data lake, the user data. Each of plurality of users has corresponding user profile. The system determines, from user data, factual user information for each user of plurality of users from corresponding user profile. Further, the system compares factual user information of plurality of users, to determine set of commonalities between plurality of users. Furthermore, system generates, for each user, integration data comprising factual user information and set of commonalities. Further, system displays, for each user, plurality of meeting objects in a meeting interface associated with the e-meeting, based on the integration data, to provide one or more profile services.

### PRIORITY CLAIM

This application claims priority to Indian provisional patent application number 202111038682 filed on Aug. 26, 2021, the disclosure of which is incorporated by reference in its entirety.

### BACKGROUND

Generally, users collaborated using collaboration technologies such as telephone, fax, e-mail, bulletin boards, and the like. For example, meetings or conferences were held on a one-on-one basis where people met and introduced one another. There used to be formal introductions as well as informal introductions, which helped in knowing the people participating in a meeting or a conference better.

Currently, a number of enterprise portals, websites, and software applications provide users with advanced collaboration capabilities such as online presence awareness (e.g., buddy lists of other users), instant messaging between users, discussion threads, and team rooms. However, professional information for meeting participants may be already segregated and virtual environments may not allow users to know more about other users. Further, current collaboration technologies may not provide platforms for integration of data from various data sources. Further, the current collaboration technologies may not include microservices to display the profiles, insights, and the connection between two or more user profiles.

Therefore, there may be a need for systems and methods for addressing at least the above-mentioned problems in the existing approaches for providing profile service management with most relevant and personalized suggestions for the users attending an electronic meeting (e-meeting).

### SUMMARY

An embodiment of present disclosure includes a system, the system generates user data corresponding to a plurality of users in an electronic meeting (e-meeting), based on meta data received from one or more data sources. The generated user data is stored in a data lake. The system retrieves, from the data lake, the user data corresponding to the plurality of users in the e-meeting. Each of the plurality of users has a corresponding user profile. The system determines, from the user data, factual user information for each user of the plurality of users from the corresponding user profile. Further, the system compares the factual user information of the plurality of users, to determine a set of commonalities between the plurality of users. Furthermore, the system generates, for each user, integration data comprising the factual user information and the set of commonalities. Further, the system displays, for each user, a plurality of meeting objects in a meeting interface associated with the e-meeting, based on the integration data, to provide one or more profile services.

Another embodiment of the present disclosure may include a method, the method includes generating user data corresponding to a plurality of users in an electronic meeting (e-meeting), based on meta data received from one or more data sources. The generated user data is stored in a data lake. The method includes retrieving, from the data lake, the user data corresponding to the plurality of users in the e-meeting. Each of the plurality of users has a corresponding user profile. Further, the method includes determining from the user data, factual user information for each user of the plurality of users from the corresponding user profile. Furthermore, the method includes comparing the factual user information of the plurality of users, to determine a set of commonalities between the plurality of users. Further, the method includes generating, for each user, integration data comprising the factual user information and the set of commonalities. Furthermore, the method includes displaying, for each user, a plurality of meeting objects in a meeting interface associated with the e-meeting, based on the integration data, to provide one or more profile services.

Yet another embodiment of the present disclosure may include a non-transitory computer-readable medium comprising machine-executable instructions that may be executable by a processor to generate user data corresponding to a plurality of users in an electronic meeting (e-meeting), based on meta data received from one or more data sources, wherein the generated user data is stored in a data lake. Further, the processor retrieves, from the data lake, user data corresponding to the plurality of users in the e-meeting. Each of the plurality of users has a corresponding user profile. The processor determines, from the user data, factual user information for each of the plurality of users from the corresponding user profile. Further, the processor compares the factual user information of the plurality of users, to determine a set of commonalities between the plurality of users. Furthermore, the processor generates, for each user, integration data comprising the factual user information and the set of commonalities. Further, the processor displays, for each user, a plurality of meeting objects in a meeting interface associated with the e-meeting, based on the integration data, to provide one or more profile services.

### BRIEF DESCRIPTION OF DRAWINGS

FIG. 1 illustrates an exemplary block diagram representation of a system for profile service management, according to an example embodiment of the present disclosure.

FIG. 2 illustrates an exemplary block diagram representation of a system architecture for profile service management, according to an example embodiment of the present disclosure.

FIG. 3 illustrates an exemplary data sequence diagram representation in reference to FIG. 2, according to an example embodiment of the present disclosure.

FIG. 4 illustrates an exemplary block diagram representation of a smart profile service architecture, according to an example embodiment of the present disclosure.

FIG. 5A illustrates an exemplary block diagram representation of an insight service architecture, according to an example embodiment of the present disclosure.

FIG. 5B illustrates an exemplary block diagram representation of a Machine Learning (ML) architecture, according to an example embodiment of the present disclosure.

FIG. 5C illustrates an exemplary flow diagram representation of method for deep learning conversion of speech, according to an example embodiment of the present disclosure.

FIG. 5D illustrates an exemplary flow diagram representation of method for data extraction from professional network, according to an example embodiment of the present disclosure.

FIG. 5E illustrates an exemplary schematic diagram representation of correlation matrix with heatmap, according to an example embodiment of the present disclosure.

FIG. 5FA illustrates an exemplary graphical representation of the statistical test, according to an example embodiment of the present disclosure.

FIG. 5FB illustrates an exemplary tabular representation of dataset before applied encoding, according to an example embodiment of the present disclosure.

FIG. 5FC illustrates an exemplary tabular representation of dataset after applied encoding, according to an example embodiment of the present disclosure.

FIG. 5G illustrates an exemplary flow diagram representation of training random forest model, according to an example embodiment of the present disclosure.

FIG. 5H illustrates an exemplary flow diagram representation of exemplary scenario of providing suggestions for the user, according to an example embodiment of the present disclosure.

FIG. 6 illustrates an exemplary block diagram representation of a people connection service, according to an example embodiment of the present disclosure.

FIG. 7 illustrates an example representation of a smart profile service management interface, according to an example embodiment of the present disclosure.

FIG. 8 illustrates a hardware platform for implementation of the system, system architecture, the insight service architecture, the Machine Learning (ML) architecture, and the people connection service architecture, according to an example embodiment of the present disclosure.

FIG. 9 illustrates a flow chart depicting a method of profile service management, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but is not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

Various embodiments describe a system and a method for profile service management. The system generates user data corresponding to a plurality of users in an electronic meeting (e-meeting), based on meta data received from one or more data sources. The generated user data is stored in a data lake. The system retrieves, from the data lake, the user data corresponding to the plurality of users in the e-meeting. Each of the plurality of users has a corresponding user profile. The system determines, from the user data, factual user information for each user of the plurality of users from the corresponding user profile. Further, the system compares the factual user information of the plurality of users, to determine a set of commonalities between the plurality of users. Furthermore, the system generates, for each user, integration data comprising the factual user information and the set of commonalities. Further, the system displays, for each user, a plurality of meeting objects in a meeting interface associated with the e-meeting, based on the integration data, to provide one or more profile services.

Further, the system may assess information of a plurality of users to generate a smart user profile. Examples of the information associated with the plurality of users may include the information obtained from an enterprise collaboration platform profile such as skills, interest, certifications, events attended by each user. In an example embodiment, the network-centrality may refer to a number of people with whom a given person interacts, i.e., in a network, it may refer to a number of nodes connected to a given node.

Embodiments disclosed herein may provide systems and methods for profile service management. The present disclosure provide the systems and methods for suggesting personalized roles or skill-based on interests of the plurality of users in the e-meeting, by looking up a user profile of the plurality of users. In an embodiment, the present disclosure describes systems and methods for determining common projects that meeting participants have worked on in the past. Further, the present disclosure describes systems and methods for determining common organizations in which the meeting participants worked together in the past. Further, the present disclosure describes systems and methods for determining common educational institutes that meeting participants have attended in the past. Furthermore, the present disclosure describes systems and methods for determining common certification that meeting participants have completed in the past.

The present disclosure describes systems and methods for connecting two or more aspirants in a particular domain. The present disclosure enables user in the e-meeting to know about another user, without introduction or asking for information. The present disclosure provides a consolidated view of the profile and professional information of the user thereby eliminating the need for exploring multiple portals to obtain the information. The present disclosure provide the systems and method for highlighting common data points (or commonalities) between the users, that may enable the users to share a strong rapport with each other. For example, the system may provide personalized and most relevant suggestions for a set of users based on the mutual interests of the set of users.

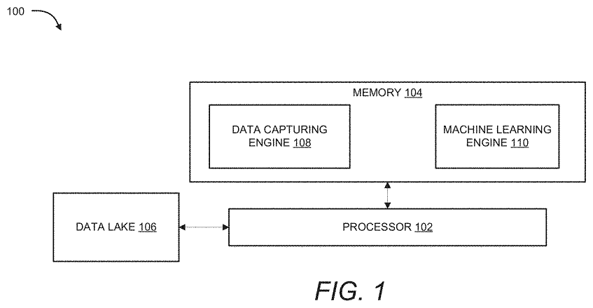

FIG. 1 illustrates an exemplary block diagram representation of a system 100 for profile service management, according to an example embodiment of the present disclosure. The system 100 may be implemented by way of a single device or a combination of multiple devices that may be operatively connected or networked together. The system 100 may be implemented in hardware or a suitable combination of hardware and software. The system 100 includes a processor 102, a memory 104, and a data lake 106. The memory 104 may include a plurality of processing engines. The processing engines may include, but are not limited to, a data capturing engine 108, a Machine Learning (ML) engine 110, and the like. In an example embodiment, the data lake 106 may store the user data. The data lake 106 may include, for example, an insight repository to store data of the plurality of users, and a factual repository to store factual information of each user, and the like.

In an example embodiment, the processor 102 may be communicatively connected to one or more computing devices (not shown in FIG. 1), one or more servers (not shown in FIG. 1) and the like. The one or more computing devices and the one or more servers may host plurality of platforms. The plurality of platforms may include, but not limited to, Enterprise Collaboration Platforms (ECP), Enterprise Resource Planning (ERP) platforms, Human Capital Management (HCM) platforms, Human Resource (HR) platforms, and professional networking platforms, and the like.

The system 100 may be a hardware device including the processor 102 executing machine-readable program instructions/processor-executable instructions, to perform profile service management. Execution of the machine-readable program instructions by the processor 102 may enable the proposed system 100 to enable profile service management. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 102 may include, for example, microprocessors, microcomputers, microcontrollers, digital signal processors, central processing units, state machines, logic circuits, and/or any devices that manipulate data or signals based on operational instructions. Among other capabilities, processor 102 may fetch and execute computer-readable instructions in a memory operationally coupled with system 100 for performing tasks such as data processing, input/output processing, keyword/feature extraction, and/or any other functions. Any reference to a task in the present disclosure may refer to an operation being or that may be performed on data.

In an example embodiment, the processor 102 may execute the data capturing engine 108 to obtain meta data corresponding to a plurality of users associated with an electronic meeting (e-meeting) of an entity. In an example embodiment, the e-meeting may be hosted in one or more collaborative meeting environments, a virtual meeting room, which may include a plurality of meeting objects. For example, the entity includes, but not limited to a university, a private organization, a company, a manufacturing unit, an electronic commerce (e-commerce) facility, a warehouse, an organization, an educational institution, and the like. The metadata may be obtained from a plurality of computing devices, one or more data sources, servers, or the data lake 106 associated with the entity.

The plurality of users associated with the e-meeting may include, but not limited to, employees of an organization, attendees or participants of a conference, a webinar, a meeting, an event, students, officers, workers, labors, and the like. The computing devices, the servers, and the data sources including the user data corresponding to the plurality of users may be associated with, but not limited to, Enterprise Collaboration Platforms (ECP), Enterprise Resource Planning (ERP) platforms, Human Capital Management (HCM) platforms, Human Resource (HR) platforms, and professional networking platforms, and the like. In an example embodiment, the meta data of the plurality of users may include, but not limited to, interests of the plurality of users from the information obtained from a professional profile such as skills, interest, certifications, events attended by the user and the like. In an example embodiment, an event attended by the plurality of users can be, but not limited to, an entity specific conference, an interview, a webinar, a meeting, a competition, and the like.

In an example embodiment, the processor 102 may execute the data capturing engine 108 to generate user data corresponding to a plurality of users in an electronic meeting (e-meeting), based on meta data received from one or more data sources. The generated user data is stored in the data lake 106. In an example embodiment, the user data includes, but are not limited to, professional data, education data, skills data, interests' data, certifications data, events attended data, and projects handled data. Further, the user data includes, but not limited to, speech to text converted data, professional networking data, Enterprise Resource Planning (ERP) data, Human Capital Management (HCM) data, Human Resource (HR) data, and the like. In an example embodiment, the user data is generated upon pre-processed the user data using, but not limited to, a data cleansing technique, a data mapping technique, a data transformation technique, and a data enrichment technique. In an example embodiment, the user data may be converted into one or more knowledge graphs and stored in the data lake 106, and the like.

In an example embodiment, the processor 102 may execute the data capturing engine 108 to retrieve, from the data lake 106, the user data corresponding to the plurality of users in thee-meeting. Each of the plurality of users has a corresponding user profile. In an example embodiment, the processor 102 may execute the Machine Learning (ML) engine 110 to determine, from the user data, factual user information for each user of the plurality of users from the corresponding user profile. In an example embodiment, the processor 102 may execute the Machine Learning (ML) engine 110 to compare the factual user information of the plurality of users, to determine a set of commonalities between the plurality of users. In an example embodiment, the processor 102 may execute the Machine Learning (ML) engine 110 to generate, for each user, integration data comprising the factual user information and the set of commonalities. In an example embodiment, the processor 102 may execute a Graphical User Interface (GUI) (not shown in FIG. 1) to display, for each user, the plurality of meeting objects in an e-meeting interface associated with the e-meeting, based on the integration data, to provide one or more profile services. The plurality of meeting objects may be one or more containers for presentation of information, such as slides, video, audio, documents, computer applications, and the like. The plurality of meeting objects may be placed into a static arrangement on the e-meeting interface. In an example embodiment, the meeting objects include, but not limited to, slides object, podium object, attendee/attender object 102, presenter object, chat object, recording object, highlight object, news object, insights object, did you know object, suggestions object, recommendation object, notes object, scene tabs, animation object, spreadsheet object, quiz object, quiz results object, video object, slides object, inactive screen object, query object, events object, and the like.

In an example embodiment, the profile services include, but not limited to, a people connect service, a feedback service, a logging and monitoring service, an adoption dashboard service, a reporting service, an insight service, and the like. In an example embodiment, the reporting service includes, but not limited to, number of meeting participants, number of meeting schedules, recurring meetings, count of meetings for each user, total time spent for each meeting, and the like.

In an example embodiment, the processor 102 may further execute Machine Learning (ML) engine 110 to assign a weighted value to the factual user information of each user profile, when the factual user information matches with that of at least one of the plurality of users. Further, the processor 102 may execute Machine Learning (ML) engine 110 to sort the plurality of user profiles based on the assigned weighted value. Furthermore, the processor 102 may execute Machine Learning (ML) engine 110 to select a first user profile for determining the set of commonalities between the plurality of users, based on the highest weightage value. In an example embodiment, the first user profile is the user profile which includes the highest weightage value among the plurality of the user profiles.

In an example embodiment, generating the user data further includes converting a speech to text. In an example embodiment, for converting the speech to text, the processor 102 may convert audio files corresponding to the speech to uniform dimensions. The dimensions comprise at least one of a sample rate, channels, and a duration of the audio files. The processor 102 may convert the audio files with uniform dimensions into a Mel spectrogram, to determine attributes of the speech in the audio files. Further, the processor 102 may convert the Mel spectrogram to Mel Frequency Cepstral Coefficients (MFCC) to determine essential frequency coefficients of the speech. Furthermore, the processor 102 may convert the essential frequency coefficients to text.

In an example embodiment, generating the user data further comprises capturing professional networking data. In an example embodiment, for capturing the professional networking data, the processor 102 may extract the professional networking data from one or more professional network websites. Furthermore, the processor 102 may segment sentences in the extracted professional networking data, and tokenize the segmented sentences. Additionally, the processor 102 may tag part of the speech in the tokenized sentences. Furthermore, the processor 102 may recognize one or more entities and one or more relations in the tagged part of the speech.

In an example embodiment, generating the user data further comprises capturing Human Capital Management (HCM) data comprising one or more features. The one or more features may include categorical features related to the plurality of users. The categorical features may include recruiting, training, payroll, compensation, performance management, opportunities, engagement, productivity, business value, and the like. In an example embodiment, for capturing the HCM data, the processor 102 may generate a correlation matrix with a heatmap by plotting a pair plot between independent features and dependent features from the one or more features. Further, the processor 102 may select the independent features comprising a highest relationship with the dependent features. Furthermore, the processor 102 may provide a feature importance score for each independent feature, based on the highest relationship with the dependent feature. Additionally, the processor 102 may store the HCM data by converting an object datatype to an integer data type of the one or more features comprising the feature importance score.

In an example embodiment, no personal or confidential information of the plurality of users may be fetched to train the machine learning engine 110.

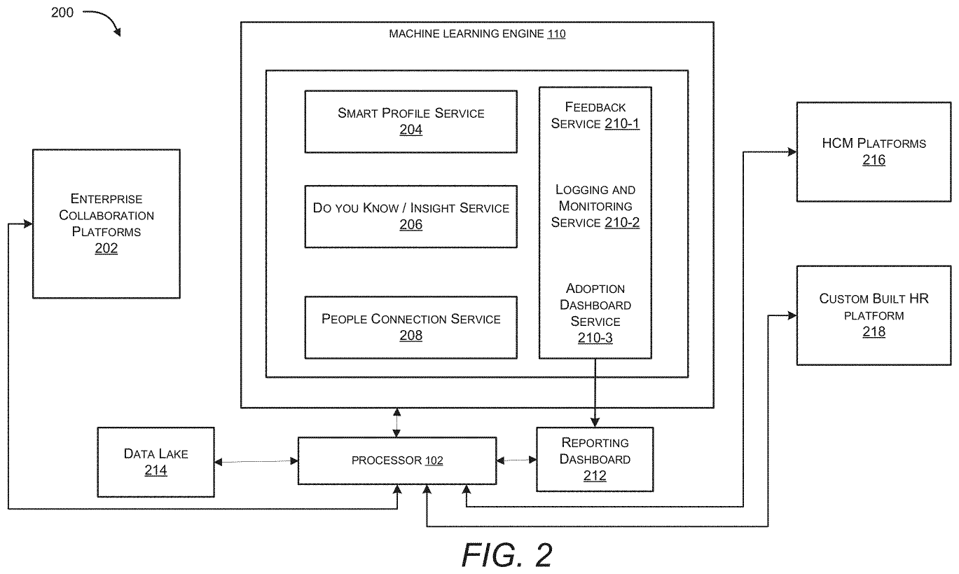

FIG. 2 illustrates an exemplary block diagram representation of a system architecture for profile service management, according to an example embodiment of the present disclosure.

In an example embodiment, the system architecture 200 may include an enterprise collaboration/integration platform 202 that may be configured to bind the data or information by or one or more end to end integration platforms (e.g., messaging application, web conference application, and the like) through one or more services executed by the ML engine 110. The one or more services may be provided to the plurality of user using the plurality of the meeting objects on the meeting interface. The enterprise collaboration/integration platform 202 may be hosted in the one or more servers or computing systems (not shown in FIG. 2), which is communicatively connect to the processor 102 as shown in FIG. 2. The enterprise collaboration/integration platforms 202 are the one or more data sources. The enterprise collaboration/integration platforms 202 may include, but not limited to, Enterprise Resource Planning (ERP) platforms, Human Capital Management (HCM) platforms 216, Human Resource (HR) platforms 218 (e.g., custom built HR platform), and professional networking platforms, and the like. In an example embodiment, the end-to-end integration platforms (e.g., the e-meeting interface) can be authenticated by a security module (not shown in FIG. 1) associated with the processor 102. The enterprise collaboration/integration platform 202 can also be integrated into end-to-end integration platforms which includes, but not limited to, a workspace application, web conference application, video conference application, a messaging application, and the like. In an example embodiment, the one more services used for integration into the end-to-end integration platforms may include a smart profile service 204, do you know/insights service 206, and people connection service 208. The ML engine 110 executes the smart profile service 204, the do you know/insights service 206, and the people connection service 208. The smart profile service 204, the do you know/insights service 206, and the people connection service 208 provide the user data to the plurality of meeting objects implemented on a reporting dashboard 212 associated with the meeting interface.

In an example embodiment, the processor 102 implements the reporting dashboard 212. The processor 102 may use the data from the one or more services such as a feedback service 210-1, a logging and monitoring service 210-2, and an adoption dashboard service 210-3, and the like to provide to the reporting dashboard 212. In an example embodiment, the feedback service 210-1 may use feedback from the plurality of users associated with the end-to-end integration platforms, and may be used for suggesting the user profile to the plurality of users. The logging and monitoring service 210-2 may be a separate insights layer where a logging action and monitoring action of the user profile may be configured. The logging and monitoring service 210-2 may store telemetry data of the user in the data lake 214. The processor 102 may obtain data from the logging and monitoring service 210-2 and the feedback service 210-1, to build a reporting service and display (i.e., graphic visualization) the data in the reporting dashboard 212. The displayed data includes, but not limited to, number of meeting participants, total number of meetings scheduled, recurring meetings, count of meetings per user, total time spent for meeting, and the like.

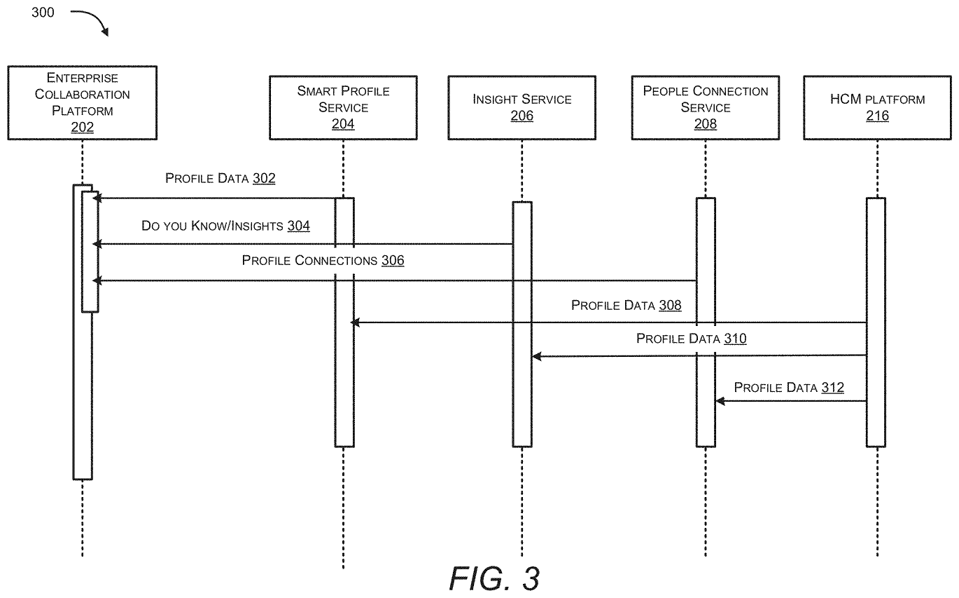

FIG. 3 illustrates an exemplary data sequence diagram representation in reference to FIG. 2, according to an example embodiment of the present disclosure.

At step 302, the enterprise collaboration platform 202 may receive profile data from the smart profile service 204. At step 304, the enterprise collaboration platform 202 may receive insights information from the insight service 206. At step 306, the enterprise collaboration platform 202 may receive profile connections information from people connection service 208.

At step 308, the smart profile service 204 may receive profile data from a HCM platform 216. At step 310, the insight service 206 may receive profile data from the HCM platform 216. At step 312, the people connection service 208 may receive profile data from the HCM platform 216.

The enterprise collaboration platform 202 may bind data or information received from the smart profile service 204, the insight service 206, and obtain profile information from the people connect service 208, and the HCM platforms 304.

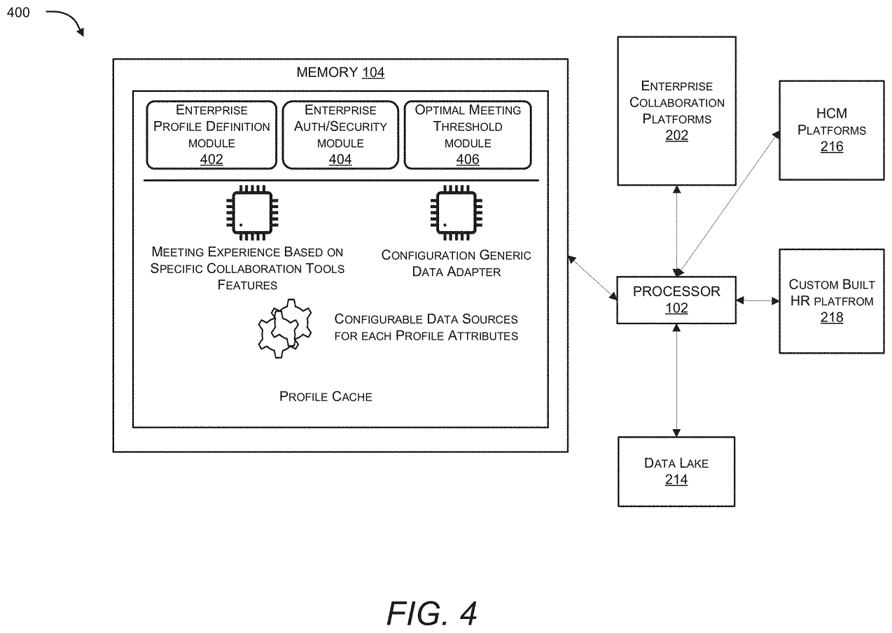

FIG. 4 illustrates an exemplary block diagram representation of a smart profile service architecture 400, according to an example embodiment of the present disclosure.

In an example embodiment, the smart profile service architecture 400 of the smart profile service 204 may be an essential service for the integration to the end-to-end platforms. The user data from the one or more data sources may be consolidated and structured. For example, the user data may be collected by the processor 102, from the enterprise collaboration platform 202 or the HCM platform 216 using a Representation State Transfer Application Programming Interface (REST API) calls. The user data may be in raw format. The processor 102 may pre-process the user data (raw data) using, but not limited to, the data cleansing technique, the data mapping technique, the data transformation technique, the data enrichment technique, and the like. The user data from the enterprise collaboration platform 202 or the HCM platform 216 may be elaborative. Further, one or more fields of the user data collected from the enterprise collaboration platform 202 or the HCM platform 216, may not be used by the processor 102. In an example embodiment, the data cleansing technique includes removing noise or unwanted data from the meta data received from enterprise collaboration platform 202 or the HCM platform 216. Further, the data cleansing technique includes determining, by the processor 102, if the user profile includes employee Identity (ID), filter out the active employee records, and removing corrupt records. In an example embodiment, the data mapping technique may include mapping one or more attributes of the HCM platform 216 required for end-to-end integration platforms (i.e., the meeting interface of a meeting application). For example, the mapped attributes may be shown in table 1 below:

TABLE 1

| | End-to-end integration platform |
|---|---|
| Attribute | (i.e., meeting interface) |
| examples | requirements example |
| EW | EmailID |
| EID | EmployeeID |
| PhotoName | profilePicture |
| BT | designation |

In an example embodiment, the data transformation technique may include converting, by the processor 102, the meta data in raw format into format required for end-to-end integration platforms (i.e., the meeting interface of the meeting application), aggregating information as required for the end-to-end integration platforms (i.e., the meeting interface of the meeting application), as shown in table 2 below:

TABLE 2

| Attribute | Meeting application |
|---|---|
| examples | API field examples |
| FN + LN | Name |
| Skill Array | Skill |
| Project details | Last three projects |

In an example embodiment, the data enrichment techniques may include enriching, by the processor 102, the meta data, by identifying the most relevant data for a current user in the e-meeting. Examples of data enrichment is shown in table 3 below:

TABLE 3

| Field | Meeting application |
|---|---|
| examples | API field examples |
| IPG - SD | Gallup strength |
| IPG - ED | Project Roles |

Further, the meta data from the one or more data sources (e.g., enterprise collaboration platforms 202, Human Capital Management (HCM) platform 216, Human Resource (HR) platform 218) may be structured to one or more profile definitions. Further, a backend API associated with the processor 102 may call a HyperText Transfer Protocol Representational State Transfer (HTTP REST) Application programming Interface (API) to the one or more data sources to collect the meta data.

For example, the processor 102, may structure meta data to a pre-defined profile definitions according to an enterprise profile definition module 402. Further, the one or more data sources for the enterprise profile definition module 402 may be configurable as per requirements. Further, the processor 102 may cache the meta data as a profile cache in the memory 104. For example, the enterprise profile definition module 402 may include a data schema of the user profile and structure of the meta data of the user. The structed data reduces the number of API calls to the one or more data sources.

In an example embodiment, the meta data may be authenticated by an enterprise authentication and security module 404. In an example embodiment, the processor 102 sets an optimal meeting threshold using an optimal meeting threshold module 406. The threshold may correspond to, but not limited to, a maximum number of users in the meeting application, limitations of the e-meeting, and the like.

In an example embodiment, the processor 102 may build a meeting experience according to the features of the collaboration tools in the meeting application, and the attributes may be collected from the HCM platform with one or more configurable data adapters associated with the processor 102.

In an example embodiment, for the one or more features, the meta data may be collected by the processor 102, via the enterprise security and authentication module 404. The processor 102 builds the meeting experience using the one or more features according to one or more features associated with the collaboration tools.

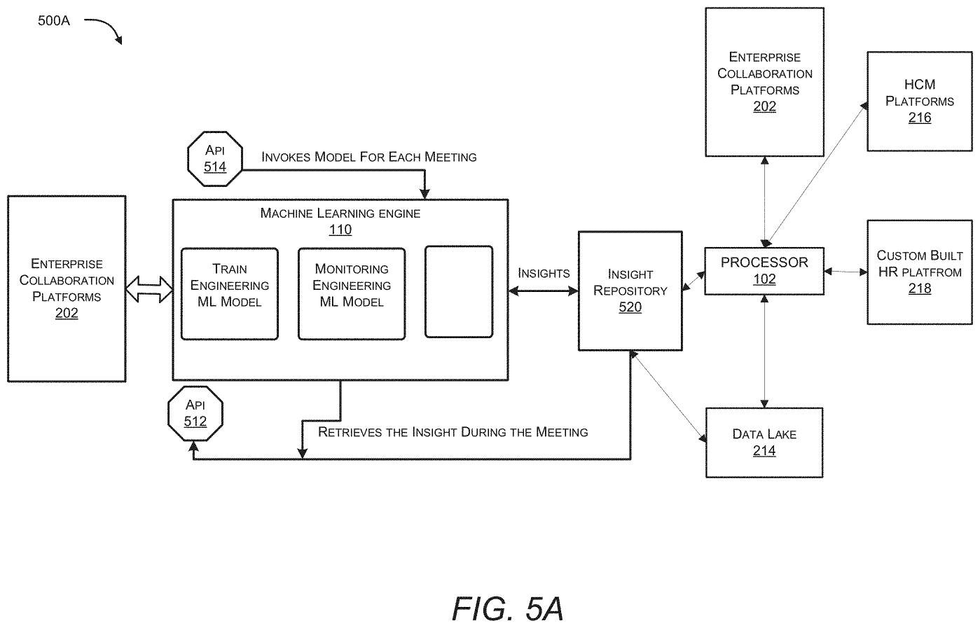

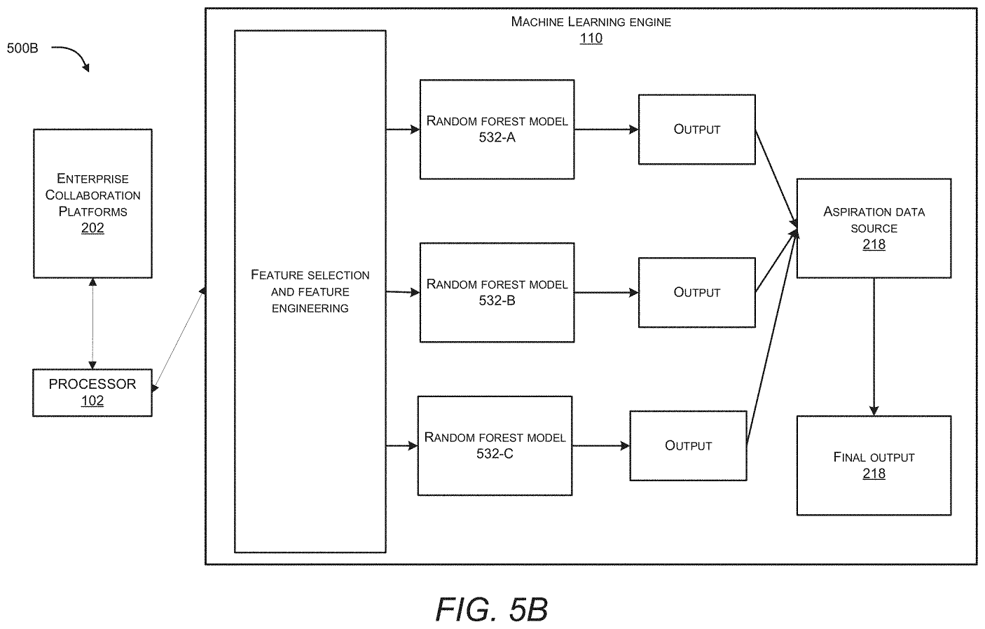

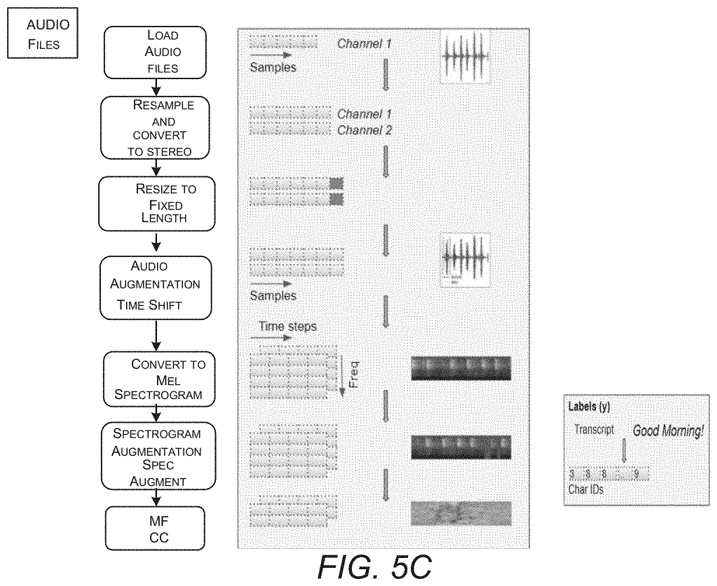

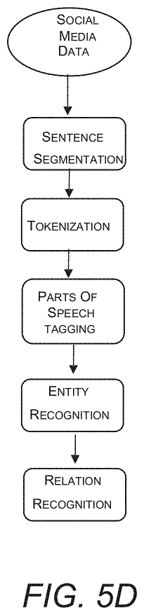

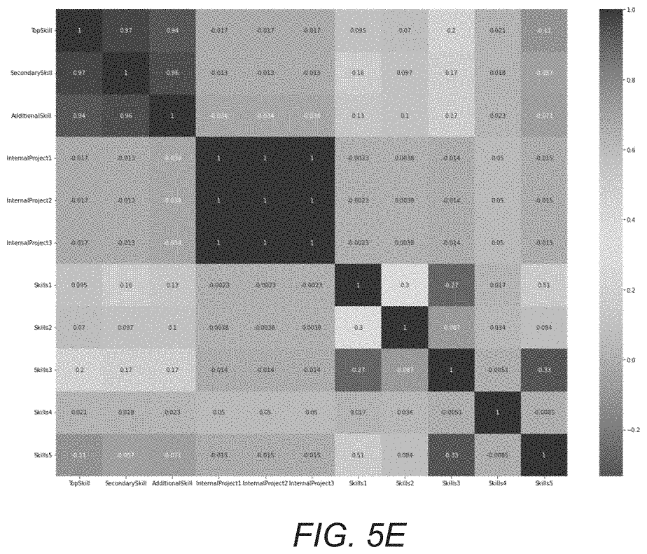

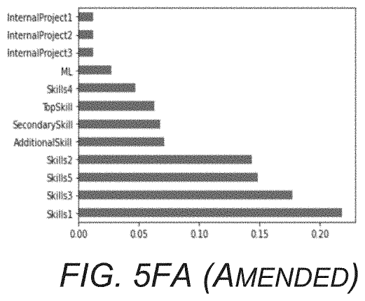

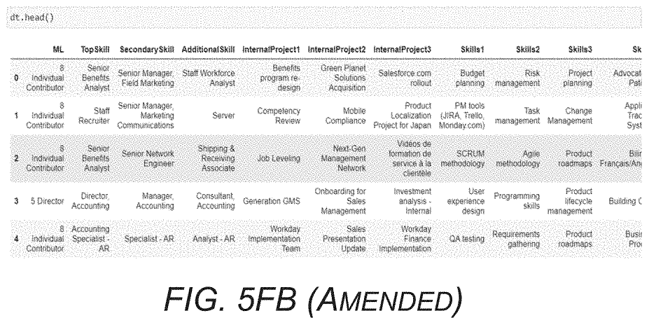

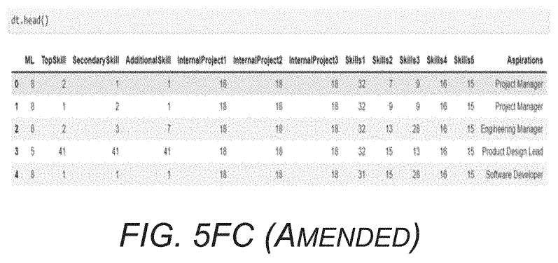

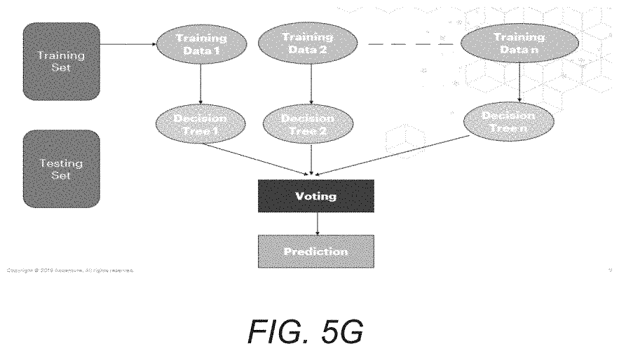

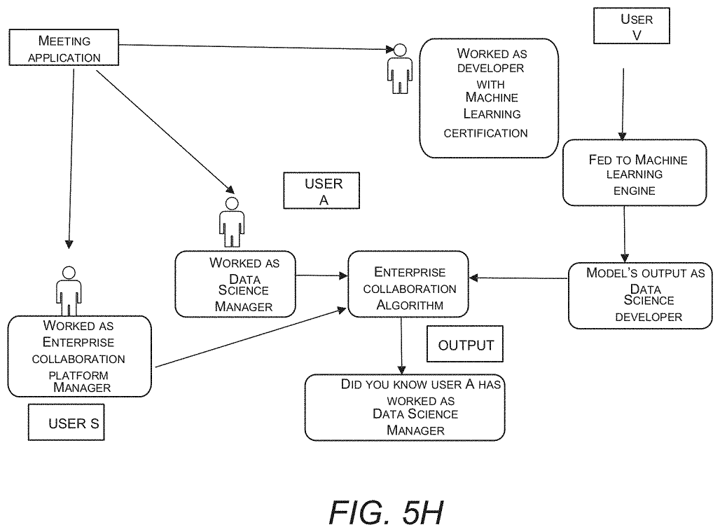

FIG. 5A illustrates an exemplary block diagram representation of an insight service architecture 500A, according to an example embodiment of the present disclosure.

In an example embodiment, the insights service 206 may work on the data associated with an insights repository 520, from the machine learning engine 110 (similar to 110). In an example embodiment, the insight repository 520 may be built with the data obtained from the HCM platform 216 and the data lake 214. The ML engine 110 may use the data in the insight repository 520 for training an engineering ML model and monitoring engineering ML model. The processor 102 stores the trained engineering ML model in the insights repository 520. The processor 102 may provide the data to the enterprise collaboration platform 202 via an intelligent APIs 512, 514. The processor 102 via the ML engine 110 may invoke the insight service architecture 500A for each e-meeting.

In an example, the machine learning engine 1110 may retrieve the data from the insights repository 520 for data modelling. The ML engine 110 may build data model for the plurality of users of the e-meeting. The ML engine 110 may validate and train the engineering ML data model using the one or more features. In an example embodiment, at least two Intelligent APIs (512, 514) may be used for capturing data intelligence by the machine learning engine 1110. For example, the APIs (512, 514) may initiate the data modelling based on the plurality of users in the e-meeting, when the e-meeting is set by the organizer. For example, the first API 512 triggers, from the machine learning engine 110, an “Aspiration” as the meeting object, during the log-in process of the user 110. Further, the second API 514 may integrate the trained engineering ML model to the enterprise collaboration platform 202. For example, the aspiration may correspond the factual user information. For example, the “Aspiration” of the logged-in user is compared with the “project roles” of the meeting participants. The APIs (512, 514) may provide the data related to the aspiration in accordance with the format of the enterprise collaboration platform 202. For example, if the “Aspiration” of the logged-in user matches with the “project roles” of the meeting participants, the “Did You Know” text may be updated in the GUI of the enterprise collaboration platform 202 (e.g., meeting application).

In an exemplary scenario, the “Aspiration” of the logged-in user may be collected by the machine learning engine 110, by validating project roles of the user from the enterprise collaboration platform 202. If the Aspiration matches with the current project roles of the meeting participant, then the “did you know” text may be presented on the GUI of the meeting application. In another example, the “did you know” text may be displayed as a user “RK is a seasoned digital marketing manager and has successfully delivered several projects”. In another example, the “did you know” text related to common projects may be displayed as “user AF and you have worked together on HR transformation project/initiative”. In another example, the “did you know” text related to common certification may be displayed as “user LH and you are certified in Senior Professional in Human Resources (SPHR)—H R C institute from human resource certification institute”. In yet another example, the “did you know” text related to common college may be displayed as “user SC and you have studied Human Resources Management from N University”. In another example, the “did you know” text related to common previous organization may be displayed as “user ABC and you have worked in XYZ organization”. In another example, the “did you know” text may be displayed as “you both started working from A company since 2010.”

FIG. 5B illustrates an exemplary block diagram representation of a Machine Learning (ML) architecture 500B, according to an example embodiment of the present disclosure.

The Machine Learning (ML) architecture 500B corresponds to the ML engine 110. user data may be retrieved from the enterprise collaboration platform 202. In one example, the meta data may include speech. The speech may be converted to text using the steps as shown in FIG. 5C. The processor 102 (shown in FIG. 5B) may load audio files received from the enterprise collaboration platform 202. Further, the processor 102 may read the audio data from the audio file and covert the audio data into a Two-Dimensional (2D) NumPy array. The 2D NumPy array includes a sequence of numbers, each representing a measurement of the intensity or amplitude of the sound at a particular moment in time. The number of such measurements may be determined, by the processor 102, by the sampling rate. For example, if the sampling rate was 44.1 kHz, the NumPy array may include a single row of 44,100 numbers for 1 second of audio. Further, the audio data can have one or two channels, known as mono or stereo, in common parlance. With the two-channel audio, another similar sequence of amplitude numbers for the second channel may be included. In other words, the NumPy array may be a 3D, with a depth of 2.

Further, the processor 102 may convert the audio to uniform dimensions. The dimensions may include sample rate, channels, duration, and the like. There may be plurality of variation in audio data items. The processor 102 may sample, audio data at different rates, or have a different number of channels. In an embodiment, the audio data may be of different durations. This implies that the dimensions of each audio file may be different. The trained engineering ML models may expect audio data to be of the same size. Due to different sizes, the processor 102 may perform data cleaning steps to standardize the dimensions of the audio. The processor 102 may resample the audio so that each audio may be sampled at the same sampling rate. Further, the processor 102 may convert audio to the same number of channels. The audio may be converted to the same audio duration. This involves, the processor 102 padding the shorter sequences or truncating longer sequences. If the quality of the audio is poor, the processor 102 may enhance the audio by applying a noise-removal technique to eliminate background noise to focus on the spoken audio.

Further, the processor 102 may perform data augmentation of raw audio data. The processor 102 may apply data augmentation techniques to add more variety to the raw audio data and enable the machine learning engine 110 to learn for a wider range of inputs. In an embodiment, the processor 102 may “time shift” the audio data to left or right randomly by a small percentage, or change the pitch or the speed of the audio by a small amount, based on a user input associated with the entity.

In an embodiment, the processor 102 may convert the raw audio data to Mel spectrograms. For example, the spectrogram may capture the nature of the audio as an image by decomposing the audio into the set of frequencies that are included in the audio. Furthermore, the processor 102 may convert the converted Mel spectrograms to the Mel Frequency Cepstral Coefficients (MFCC). For human speech, it sometimes helps the processor 102 to take one additional step and convert the Mel Spectrogram into MFCC. The MFCCs may produce a compressed representation of the Mel spectrogram by extracting only the most essential frequency coefficients, which correspond to the frequency ranges at which humans speak.

Furthermore, the processor 102 may perform data augmentation of the spectrograms using a technique known as spec augment technique. This step involves frequency and time masking by the processor 102, to randomly mask out either vertical (i.e., time mask) or horizontal (i.e., frequency mask) bands of information from the spectrogram.

Further, the processor 102 (shown in FIG. 5B) may extract the meta data from the professional network website/application as shown in FIG. 5D. The processor 102 may count the number of characters present in a page of the professional network, number of words present in the page, number of capital characters present in the page, number of capital words present in the page. The processor 102 may return a dictionary of punctuations with the counts. The punctuations can be used as separate features, number of words in the single quotation and double quotation, number of sentences in the page, number of unique words in the page, number of times users used a hashtag, number of stop words used in a professional network post, and the like.

Further, the processor 102 may calculate average word length, by dividing the counts of characters by counts of words. Furthermore, the processor 102 may calculate average sentence length, by dividing the counts of words by the counts of sentences. Furthermore, the processor 102 may determine unique words vs word count feature. This feature may be represented as a ratio of unique words to a total number of words. Further, the processor 102 may determine stop words count vs words counts feature. This feature may also be represented as a ratio of counts of stop words to the total number of words.

In an example embodiment, the processor 102 may extract the professional networking data from one or more professional network websites. Further, the processor 102 may segment sentences in the extracted professional networking data, and tokenize the segmented sentences. Furthermore, the processor 102 may tag part of the speech in the tokenized sentences. Additionally, the processor 102 may recognize one or more entities and one or more relations in the tagged part of the speech.

Further, the processor 102 (shown in FIG. 5B) may perform feature engineering on the meta data (i.e., HCM data) by generating correlation matrix with heatmap as shown in FIG. 5E. In an example embodiment, the processor 102 may generate a correlation matrix with a heatmap by plotting a pair plot between independent features and dependent features from the one or more features. In an example embodiment, the processor 102 may select the independent features comprising a highest relationship with the dependent features. In an example embodiment, the processor 102 may provide a feature importance score for each independent feature, based on the highest relationship with the dependent feature. In an example embodiment, the processor 102 may store the HCM data in the data lake 214, by converting an object datatype to an integer datatype of the one or more features comprised in the feature importance score.

FIG. 5E illustrates the correlation matrix with the heatmap. The heatmap may be a graphical representation of 2D (two-dimensional) data. Each data value represents in a matrix. Firstly, the processor 102 may plot the pair plot between all independent features and dependent features. The plot may be a relation between dependent and independent features. If the relation between the independent feature and the dependent feature is less than 0.2, then the processor 102 may choose that independent feature for building the machine learning engine 110. Further, the processor 102 may perform statistical tests, that can be used to select the independent features which have the strongest relationship with the dependent feature. The processor 102 may use “select K best method”, which determines high co-relation of the independent feature with the dependent feature. Further, the processor 102, using an extra trees classifier method, provides importance of each independent feature with a dependent feature. The feature importance score may provide a score for each feature of the user data, the higher the score more important or relevant to the feature towards the output variable. The graphical representation of the statistical test is shown in FIG. 5FA.

In an example embodiment, the processor 102 may be configured to handle missing values. In some datasets, there may be Not Applicable (NA) values in the one or more features that are referred to as missing data/values. The processor 102 may replace the missing values with mean or median to numerical data and for categorical data with mode. For example, the data with null values can be handled by initially removing the NA values in entire rows of the datasets. Further, the processor 102 may remove the NA values by replacing NA values with “0”, and replace 0 with mean, median, mode. Furthermore, the processor 102 may be configured to handle imbalanced data, to reduce overfitting and underfitting problem. For example, if a feature has a factor level 2 (0 and 1), and consists of 1's is 5% and 0's is 95% instances, Then the data may be “imbalanced”.

In an example embodiment, the processor 102 may be configured to handle outliers. Firstly, the processor 102 may calculate the skewness of the features and determine whether the features are positively skewed, negatively skewed, or normally skewed. Alternatively, the processor 102 may plot the boxplot to features and check if any values are out of bounds or not. If the values are out of bounds, then the features are referred to as the “outliers”.

In an example embodiment, the processor 102 may perform encoding on the features. The HCM data may include object datatypes. For building a machine learning model (e.g., engineering ML model), all features need to be in integer datatypes. The processor 102 may use label encoder and hot encoder to convert object datatype to integer datatype. FIG. 5FB illustrates an exemplary tabular representation of dataset before applied encoding. FIG. 5FC illustrates an exemplary tabular representation of dataset after applied encoding.

Further, FIG. 5G illustrates an exemplary flow diagram representation of training random forest model 532-A, 532-B, and 532-C (shown in FIG. 5B), according to an example embodiment of the present disclosure. In an example embodiment, the ML engine 110 may create three different models (532-A, 532-B, and 532-C) for three different data sources. The processor 102 may perform data pre-processing on the meta data received from the one or more data sources. Once the data is pre-processed, the processor 102 may train the random forest models (532-A, 532-B, and 532-C) with the pre-processed data. The random forest models (532-A, 532-B, and 532-C) may include a classifier that includes a number of decision trees on various subsets of the given dataset and takes the average to improve the predictive accuracy of that dataset. Instead of relying on one decision tree, the random forest model takes the prediction from each tree and based on the majority votes of predictions, predicts the final output. The greater number of trees in the forest leads, higher the accuracy that prevents the problem of overfitting. The random forest model may function in two phases, a first phase to create the random forest by combining N decision tree, and a second phase to make predictions for each tree created in the first phase. For example, the random forest model may function as shown in FIG. 5G and perform the following steps.
Step-1: select random K data points from the training set.
Step-2: build the decision trees associated with the selected data points (subsets).
Step-3: choose the number N for decision trees that the ML engine 110 needs to build.
Step-4: repeat steps 1 and 2.
Step-5: for new data points, find the predictions of each decision tree, and assign the new data points to the category that wins the majority votes.

The machine learning engine 1110 via the random forest models 532-A, 532-B, and 532-C may determine probable aspiration (i.e., factual user information). The machine learning engine 110 may create aspiration with different skills of the plurality of users. With the help of different skills and technical domains of the plurality of users, the machine learning engine 110 may create a probable “aspiration’ with the combination of the skills and domain of the plurality of users. In addition, the machine learning engine 110 may determine aspiration with the help of the aspiration dataset to find the aspiration of an employee. From all the data source, the machine learning engine 110 may receive the data which may be fed to the probable aspiration dataset. From this data set combination, the machine learning engine 110 may provide the aspiration of the employee.

FIG. 5H illustrates an exemplary flow diagram representation of exemplary scenario of providing suggestions for the user, according to an example embodiment of the present disclosure.

In this use case, consider there are three employees who have joined an e-meeting. For example, User “A” has experience of handling multiple data science projects. User “S” has experience of handling multiple enterprise collaboration platform projects. Further, user “V” has experience in working in multiple projects as a software developer. Also, the user “V” has certification in machine learning. Accordingly, when the user “V” joins the e-meeting, the processor 102 collects the meta data of user “V” such as the enterprise collaboration platform data, the professional network data, and the speech. The processor 102 generated the user data from the meta data and provides the user data to the machine learning engine 110. The machine learning engine 110 may process the user data and output “did you know” text as “Data Science developer” of User “A to other users such as the user S, and user V. This data is pushed to the enterprise collaboration platform 202. Information for users “A” and “S” are also fed to the enterprise collaboration platform 202. The machine learning engine 110 may determine that user V's aspiration matches with user A's skillset, because user V wants to work in data science domain and user A has worked as a data science manager. Hence, the user V may be prompted with the meeting object such as “Did you know” text that corresponds to “Did you know user A has worked as data science manager”.

The enterprise collaboration platform 202 may receive “aspiration” from the machine learning model 110 of the logged-in user. The machine learning engine 110 may validate user's project roles from enterprise collaboration platform 202. If the Aspiration matches with of the current project roles of the meeting participant, then the “did you know” text is presented to the user. For example, the processor 102 may display on the GUI of the enterprise collaboration platform 202 as to the user of the e-meeting as “RK has been a seasoned digital marketing manager and has successfully delivered several projects”.

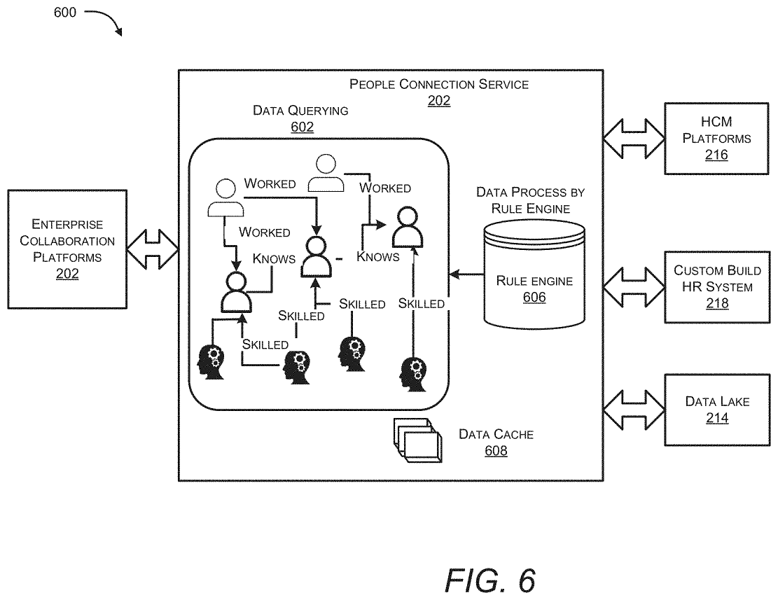

FIG. 6 illustrates an exemplary block diagram representation of a people connection service architecture 600, according to an example embodiment of the present disclosure.

The people connection service architecture 600 corresponds to the people connection service 208. In an example embodiment, the enterprise profile data may be built from a plurality of computing devices/data sources for the meeting participants by a data querying module 602. The user data may be processed by a rule engine 606. In an example embodiment, the rule engine 606 may include a set of rules/parameters, based on which the profile data may be built. The processed data may then be cached in a data cache 608. On querying the data from the API 512, the connections between the meeting participants may be determined.

The profile data from the enterprise platforms and other platforms may be stored as one or more knowledge graph in the data lake 214. In an example embodiment, the knowledge graph may be used to depict the people connections. The connections are defined as the rule parameters in the rule engine 606. The retrieved data from the data lake 216 is processed based on the one or more rules. The rules include people connections, which are determined in the knowledge graph as relationships defined as per definitions of the rule engine 606. The processor 102 may traverse the knowledge graph data to determine the connections. The traversing through the graph may be performed by the processor 102, by using a data query language. The knowledge graph may be built by the processor 102, by traversing through the relationship of the connections by following the rules. The rules help to determine the connection between two profiles based on the rule parameters. For example, the rule engine 606 may obtain the enterprise data from enterprise collaboration platform 202 or from the data lake 214 or any other external data source for the meeting participants. The projects data may be fetched from the enterprise collaboration platform 202, and the data lake 214 provides the data about the skillset of the plurality of users.

Further, new rules can be added to the existing rules by the rule engine 606. The processor 102 may process the knowledge graph. Each instance of the user data may be stored as a node. The rule parameters are the connections and the user data of the meeting participants. For example, the processor 102 may compare the project details of the two user profiles, and if there is a match, then the project may be used for knowledge graph. For example, from the user data of user “R” and user “Y”, the processor 102 determines that both user “R” and “Y” worked on “T meeting experience project”. Hence, the connection between the both user “R” and “Y” is that they both worked on same project. Here, the processed data is cached. On querying the data from the API 512, the processor 102 determines the connections between the meeting participants. For example, the processor 102 may determine the connection between three users, based on the matching data from the API 514 and the data lake 214. For example, the processor 102 outputs that user R and user Y worked on same project, User Y and user S attended the same technical training. Hence, user RK is connected to user S through user Y. In an example embodiment, the people connection service 208 and the insights service 206 are inter related to each other as the data comparison logic may be same.

In another example, consider four users, RK, L, Y, and S are the meeting participants. The user “RK” and “S” have same skill set. Further, the user S and user L have the same past work experience. User L and user Y worked on the same project in the current organization. The people connection service 208 may output people connection, which corresponds to outputting a text as the “user RK is connected to Y through S, as S knows Y and L are in same project”.

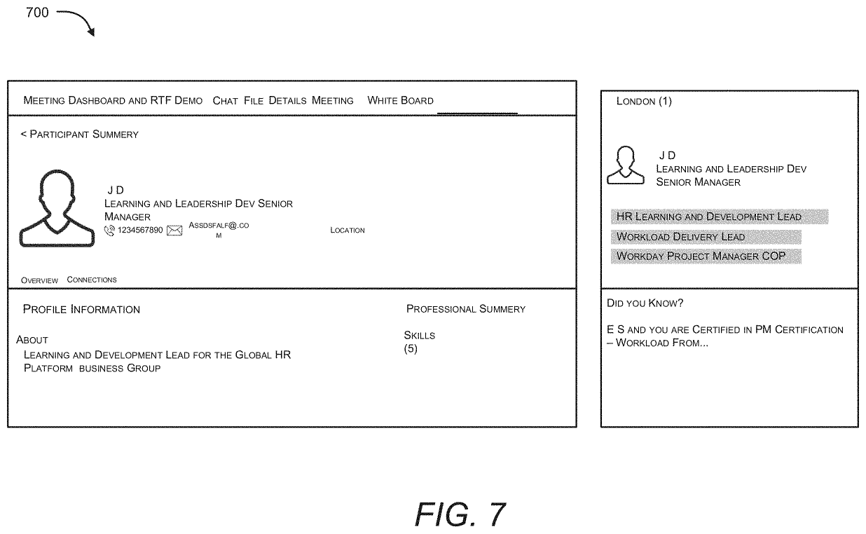

FIG. 7 illustrates an example representation of a smart profile service management interface, according to an example embodiment of the present disclosure.

In an example embodiment, the example representation in FIG. 7 highlights a consolidated view of the user profile and professional information (right side) within the meeting interface. The example representation depicts that the user may not be need to explore multiple portals to obtain information of another user in the e-meeting. The example representation further highlights commonalities between the participants. Further, by providing the commonalties, it enables the users to share a strong rapport with each other. The commonalties allow personalized and most relevant suggestions for the participants based on the mutual interests of the participants.

For example, if three participants are present in the e-meeting where among the three, user “JD” is an executive coach, a seasoned product manager, and a pioneer in patent filings, user “M” is a software development engineer and an aspiring product manager and J is a business consultant and aspiring to become a business leader. In the above scenario, when user “M” is exploring the profile of the user “JD”, the smart profile service 204 may anticipate the interests of the user “M” by reading his behavior through the events he has attended, certifications he has completed, and skills he has been building, and the like. Based on these interests', the processor 102 may display most relevant suggestion to the user “M” from the user “JD's” profile. In this scenario, the smart profile service 204 may provide to the processor 102 as the text corresponding to “did you know—JD is a seasoned product manager and has successfully launched multiple products in the market”. Similarly, when the user “J” is exploring the profile of the user “JD”, the smart profile service 204 may provide to the processor 102 as the text corresponding to “did you know—JD is an executive coach and mentored several peers to take leadership positions”.

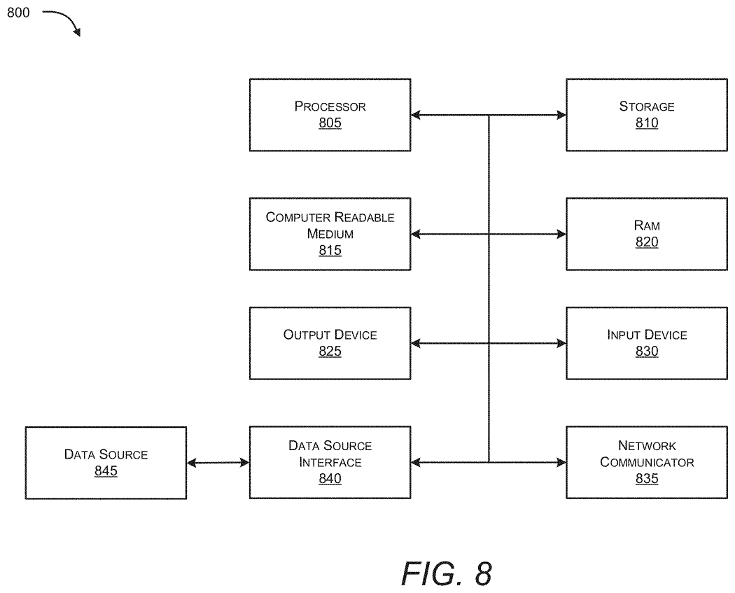

FIG. 8 illustrates a hardware platform 800 for implementation of the disclosed system 100, the system architecture 200, the insight service architecture 500A, the Machine Learning (ML) architecture 500B, and the people connection service architecture 600, according to an example embodiment of the present disclosure. For the sake of brevity, the construction, and operational features of the system 100 the system architecture 200, the insight service architecture 500A, the Machine Learning (ML) architecture 500B, and the people connection service architecture 600, which are explained in detail above are not explained in detail herein. Particularly, computing machines such as but not limited to internal/external server clusters, quantum computers, desktops, laptops, smartphones, tablets, and wearables which may be used to execute the system 100 the system architecture 200, the insight service architecture 500A, the Machine Learning (ML) architecture 500B, and the people connection service architecture 600, or may include the structure of the hardware platform 800. As illustrated, the hardware platform 800 may include additional components not shown, and some of the components described may be removed and/or modified. For example, a computer system with multiple GPUs may be located on external-cloud platforms including Amazon Web Services, or internal corporate cloud computing clusters, or organizational computing resources.

The hardware platform 800 may be a computer system such as the system 100 that may be used with the embodiments described herein. The computer system may represent a computational platform that includes components that may be in a server or another computer system. The computer system may execute, by the processor 805 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 805 that executes software instructions or code stored on a non-transitory computer-readable storage medium 810 to perform methods of the present disclosure. The software code includes, for example, instructions to gather data and documents and analyze documents.

The instructions on the computer-readable storage medium 810 are read and stored the instructions in storage 815 or in random access memory (RAM). The storage 815 may provide a space for keeping static data where at least some instructions could be stored for later execution. The stored instructions may be further compiled to generate other representations of the instructions and dynamically stored in the RAM such as RAM 820. The processor 805 may read instructions from the RAM 820 and perform actions as instructed.

The computer system may further include the output device 825 to provide at least some of the results of the execution as output including, but not limited to, visual information to users, such as external agents. The output device 825 may include a display on computing devices and virtual reality glasses. For example, the display may be a mobile phone screen or a laptop screen. GUIs and/or text may be presented as an output on the display screen. The computer system may further include an input device 830 to provide a user or another device with mechanisms for entering data and/or otherwise interact with the computer system. The input device 830 may include, for example, a keyboard, a keypad, a mouse, or a touchscreen. Each of these output devices 825 and input device 830 may be joined by one or more additional peripherals. For example, the output device 825 may be used to display the results such as bot responses by the executable chatbot.

A network communicator 835 may be provided to connect the computer system to a network and in turn to other devices connected to the network including other clients, servers, data stores, and interfaces, for example. A network communicator 835 may include, for example, a network adapter such as a LAN adapter or a wireless adapter. The computer system may include a data sources interface 840 to access the data source 845. The data source 845 may be an information resource. As an example, a database of exceptions and rules may be provided as the data source 845. Moreover, knowledge repositories and curated data may be other examples of the data source 845.

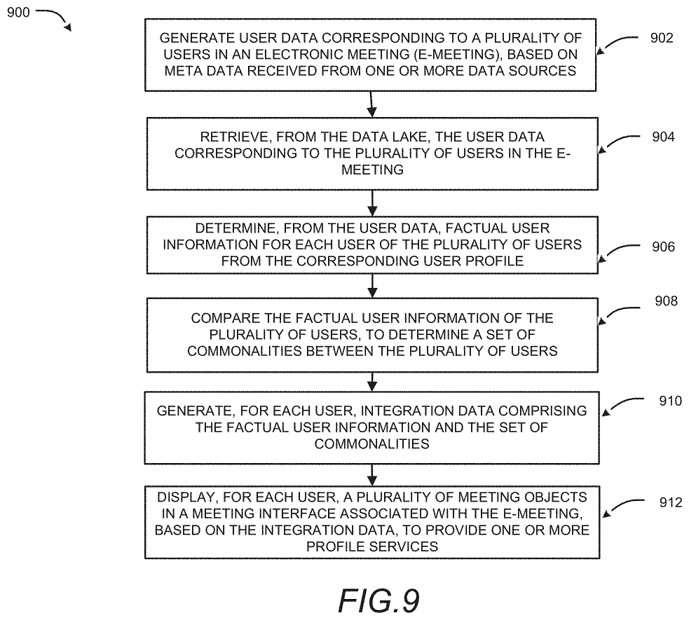

FIG. 9 illustrates a flow chart depicting a method 900 of profile service management, according to an example embodiment of the present disclosure.

At block 902, the method 900 may include generating, by the processor 102, user data corresponding to a plurality of users in an electronic meeting (e-meeting), based on meta data received from one or more data sources. The generated user data is stored in a data lake 106.

At block 904, the method 900 may include retrieving, by the processor 102, from the data lake 102, the user data corresponding to the plurality of users in e-meeting. Each of the plurality of users has a corresponding user profile.

At block 906, the method 900 may include determining, by the processor 102, from the user data, factual user information for each user of the plurality of users from the corresponding user profile.

At block 908, the method 900 may include comparing, by the processor 102, the factual user information of the plurality of users, to determine a set of commonalities between the plurality of users.

At block 910, the method 900 may include generating, by the processor 102, for each user, integration data comprising the factual user information and the set of commonalities.

At block 912, the method 900 may include displaying, by the processor 102, for each user, a plurality of meeting objects in a meeting interface associated with the e-meeting, based on the integration data, to provide one or more profile services.

The order in which the method 900 is described is not intended to be construed as a limitation, and any number of the described method blocks may be combined or otherwise performed in any order to implement the method 900 or an alternate method. Additionally, individual blocks may be deleted from the method 900 without departing from the spirit and scope of the present disclosure described herein. Furthermore, the method 900 may be implemented in any suitable hardware, software, firmware, or a combination thereof, that exists in the related art or that is later developed. The method 900 describes, without limitation, the implementation of the system 100. A person of skill in the art will understand that method 900 may be modified appropriately for implementation in various manners without departing from the scope and spirit of the disclosure.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

We claim:

1. A system comprising:
a processor;
a memory coupled to the processor, wherein the memory comprises processor-executable instructions, which on execution, causes the processor to:
generate user data corresponding to a plurality of users in an electronic meeting (e-meeting), based on meta data received from one or more data sources, wherein the generated user data is stored in a data lake;
retrieve, from the data lake, the user data corresponding to the plurality of users in the e-meeting, wherein each of the plurality of users has a corresponding user profile;
determine, from the user data, factual user information for each user of the plurality of users from the corresponding user profile;
compare the factual user information of the plurality of users, to determine a set of commonalities between the plurality of users;
generate, for each user, integration data comprising the factual user information and the set of commonalities; and
display, for each user, a plurality of meeting objects in a meeting interface associated with the e-meeting, based on the integration data, to provide one or more profile services.

2. The system as claimed in claim 1, wherein the processor is further configured to:
assign a weighted value to the factual user information of each user profile, when the factual user information matches with that of at least one of the plurality of users;
sort the plurality of user profiles based on the assigned weighted value; and
select a first user profile for determining the set of commonalities between the plurality of users, based on the highest weightage value.

3. The system as claimed in claim 1, wherein the user data comprises at least one of professional data, education data, skills data, interests data, certifications data, events attended data, projects handled data, speech to text converted data, professional networking data, Enterprise Resource Planning (ERP) data, Human Capital Management (HCM) data, and Human Resource (HR) data.

4. The system as claimed in claim 3, wherein the user data is generated upon pre-processing the user data using at least one of a data cleansing technique, a data mapping technique, a data transformation technique, and a data enrichment technique, wherein the user data is converted into one or more knowledge graphs and stored in the data lake.

5. The system as claimed in claim 1, wherein generating the user data further comprises converting a speech to text, wherein for converting the speech to text the processor is further configured to:
convert audio files corresponding to the speech to uniform dimensions, wherein the dimensions comprise at least one of a sample rate, channels, and a duration of the audio files;
convert the audio files with uniform dimensions into a Mel spectrogram, to determine attributes of the speech in the audio files;
convert the Mel spectrogram to Mel Frequency Cepstral Coefficients (MFCC) to determine essential frequency coefficients of the speech; and
convert the essential frequency coefficients to text.

6. The system as claimed in claim 1, wherein generating the user data further comprises capturing professional networking data, wherein for capturing the professional networking data the processor is configured to:
extract the professional networking data from one or more professional network websites;
segment sentences in the extracted professional networking data, and tokenize the segmented sentences;
tag part of the speech in the tokenized sentences; and
recognize one or more entities and one or more relations in the tagged part of the speech.

7. The system as claimed in claim 1, wherein generating the user data further comprises capturing Human Capital Management (HCM) data comprising one or more features, wherein for capturing the HCM data, the processor is configured to:
generate a correlation matrix with a heatmap by plotting a pair plot between independent features and dependent features from the one or more features;
select the independent features comprising a highest relationship with the dependent features;
provide an feature importance score for each independent feature, based on the highest relationship with the dependent feature; and
store the HCM data by converting an object datatype to an integer datatype of the one or more features comprising the feature importance score.

8. The system as claimed in claim 1, wherein the one or more data sources comprise at least one of Enterprise Collaboration Platforms (ECP), Enterprise Resource Planning (ERP) platforms, Human Capital Management (HCM) platforms, Human Resource (HR) platforms, and professional networking platforms.

9. The system as claimed in claim 1, wherein the profile services comprise at least one of a people connect service, a feedback service, a logging and monitoring service, an adoption dashboard service, a reporting service, and an insight service, wherein the reporting service comprise at least one of number of meeting participants, number of meeting schedules, recurring meetings, count of meetings for each user, and total time spent for each meeting.

10. A method comprising:
generating, by a processor associated with a system, user data corresponding to a plurality of users in an electronic meeting (e-meeting), based on meta data received from one or more data sources, wherein the generated user data is stored in a data lake;
retrieving, by the processor, from the data lake, the user data corresponding to the plurality of users in the e-meeting, wherein each of the plurality of users has a corresponding user profile;
determining, by the processor, from the user data, factual user information for each user of the plurality of users from the corresponding user profile;
comparing, by the processor, the factual user information of the plurality of users, to determine a set of commonalities between the plurality of users;
generating, by the processor, for each user, integration data comprising the factual user information and the set of commonalities; and
displaying, by the processor, for each user, a plurality of meeting objects in a meeting interface associated with the e-meeting, based on the integration data, to provide one or more profile services.

11. The method as claimed in claim 10, wherein the method further comprises:
assigning, by the processor, a weighted value to the factual user information of each user profile, when the factual user information matches with that of at least one of the plurality of users;
sorting, by the processor, the plurality of user profiles based on the assigned weighted value; and
selecting, by the processor, a first user profile for determining the set of commonalities between the plurality of users, based on the highest weightage value.

12. The method as claimed in claim 10, wherein the user data comprises at least one of professional data, education data, skills data, interests data, certifications data, events attended data, projects handled data, speech to text converted data, professional networking data, enterprise resource planning (ERP) data, human capital management (HCM) data, and Human Resource (HR) data.

13. The method as claimed in claim 12, wherein the user data is generated upon pre-processing the user data using at least one of a data cleansing technique, a data mapping technique, a data transformation technique, and a data enrichment technique, wherein the user data is converted into one or more knowledge graphs and stored in the data lake.

14. The method as claimed in claim 10, wherein generating the user data further comprises converting a speech to text, wherein converting the speech to text further comprises:
converting, by the processor, audio files corresponding to the speech to uniform dimensions, wherein the dimensions comprise at least one of a sample rate, channels, and a duration of the audio files;
converting, by the processor, the audio files with uniform dimensions into a Mel spectrogram, to determine attributes of the speech in the audio files;
converting, by the processor, the Mel spectrogram to Mel Frequency Cepstral Coefficients (MFCC) to determine essential frequency coefficients of the speech; and
converting, by the processor, the essential frequency coefficients to text.

15. The method as claimed in claim 10, wherein generating the user data further comprises capturing professional networking data, wherein capturing the professional networking data further comprises:
extracting, by the processor, the professional networking data from one or more professional network websites;
segmenting, by the processor, sentences in the extracted professional networking data, and tokenize the segmented sentences;
tagging, by the processor, part of the speech in the tokenized sentences; and
recognizing, by the processor, one or more entities and one or more relations in the tagged part of the speech.

16. The method as claimed in claim 10, wherein generating the user data further comprises capturing Human Capital Management (HCM)data comprising one or more features, wherein capturing the HCM data further comprises:
generating, by the processor, a correlation matrix with a heatmap by plotting a pair plot between independent features and dependent features from the one or more features;
selecting, by the processor, the independent features comprising a highest relationship with the dependent features;
providing, by the processor, a feature importance score for each independent feature, based on the highest relationship with the dependent feature; and
storing, by the processor, the HCM data by converting an object datatype to an integer datatype of the one or more features comprising the feature importance score.

17. The method as claimed in claim 10, wherein the one or more data sources comprise at least one of Enterprise Collaboration Platforms (ECP), Enterprise Resource Planning (ERP) platforms, Human Capital Management (HCM) platforms, Human Resource (HR) platforms, and professional networking platforms.

18. The method as claimed in claim 10, wherein the profile services comprise at least one of a people connect service, a feedback service, a logging and monitoring service, an adoption dashboard service, a reporting service, and an insight service, wherein the reporting service comprise at least one of number of meeting participants, number of meeting schedules, recurring meetings, count of meetings for each user, and total time spent for each meeting.

19. A non-transitory computer-readable medium comprising machine-readable instructions that are executable by a processor to:
generate user data corresponding to a plurality of users in an electronic meeting (e-meeting), based on meta data received from one or more data sources, wherein the generated user data is stored in a data lake;
retrieve, from the data lake, the user data corresponding to the plurality of users in thee-meeting, wherein each of the plurality of users has a corresponding user profile;
determine, from the user data, factual user information for each user of the plurality of users from the corresponding user profile;
compare the factual user information of the plurality of users, to determine a set of commonalities between the plurality of users;
generate, for each user, integration data comprising the factual user information and the set of commonalities; and
display, for each user, a plurality of meeting objects in a meeting interface associated with the e-meeting, based on the integration data, to provide one or more profile services.

20. The non-transitory computer-readable medium as claimed in claim 19, wherein the processor is further configured to:
assign a weighted value to the factual user information of each user profile, when the factual user information matches with that of at least one of the plurality of users;
sort the plurality of user profiles based on the assigned weighted value; and
select a first user profile for determining the set of commonalities between the plurality of users, based on the highest weightage value.
